(19) United States
(12) Patent Application Publication
(10) Pub. No.: US 2008/0000530 A1
(43) Pub. Date: Jan. 3, 2008

(54) GAS FLOW CONTROL BY DIFFERENTIAL PRESSURE MEASUREMENTS

(75) Inventors: DAVID P. SUN, Mountain View, CA (US); Daniel J. Coffman, Austin, TX (US); Sophia M. Velastegui, Cupertino, CA (US); Steven E. Gianoulakis, Albuquerque, NM (US); Abhijit Desai, Fremont, CA (US)

Correspondence Address: JANAH & ASSOCIATES, P.C., 650 DELANCEY STREET, SUITE 106, SAN FRANCISCO, CA, 94107, US

(73) Assignee: Applied Materials, Inc.

(21) Appl. No.: 11/754,244

(22) Filed: May 25, 2007

Related U.S. Application Data
(60) Provisional application No. 60/810,446, filed on Jun. 2, 2006.

(51) Int. Cl. G05D 7/06

(52) U.S. Cl. 137/487.5

(57) ABSTRACT

A gas flow comparator comprises a gas control mounted on a gas tube to set a gas flow or pressure of a gas passing thorough the gas tube. A principal flow splitter comprises an inlet port connected to the gas tube. First and second flow restrictors are connected to the principal flow splitter. A pair of secondary flow splitters are each connected to a restrictor outlet of a flow restrictor. A differential pressure gauge is connected to the secondary flow splitters. A pair of nozzle holders are connected to the secondary flow splitters and are capable of being connected to first and second nozzles. In operation, the pressure differential gauge registers a pressure differential proportional to a variation in the passage of gas through the first and second nozzles.

### CROSS-REFERENCE

The present application claims the benefit of U.S. Provisional Application No. 60/810,446, filed on Jun. 2, 2006, which is incorporated by reference herein and in its entirety.

### BACKGROUND

In the fabrication of electronic circuits and displays, materials such as semiconductor, dielectric and conductor materials, are deposited and patterned on a substrate. Some of these materials are deposited by chemical vapor deposition (CVD) or physical vapor deposition (PVD) processes, and others may be formed by oxidation or nitridation of substrate materials. For example, in chemical vapor deposition processes, a process gas is introduced into a chamber and energized by heat or RF energy to deposit a film on the substrate. In physical vapor deposition, a target is sputtered with process gas to deposit a layer of target material onto the substrate. In etching processes, a patterned mask comprising a photoresist or hard mask, is formed on the substrate surface by lithography, and portions of the substrate surface that are exposed between the mask features are etched by an energized process gas. The process gas may be a single gas or a mixture of gases. The deposition and etching processes, and additional planarization processes, are conducted in a sequence to process the substrate to fabricate electronic devices and displays.

The substrate processing chambers comprise gas distributors which have a plurality of gas nozzles to introduce process gas in the chamber. In one version, the gas distributor is a showerhead comprising a plate or enclosure having a plurality of gas nozzles. In another version, the gas distributor comprises individual gas nozzles which pass through a sidewall of the chamber to inject gas laterally into the chamber from around the periphery of the substrate. In yet another version, a plurality of individual gas nozzles inject gas vertically into the chamber from around the perimeter of the substrate. In yet a further version, the gas distributor comprises a showerhead having an array of gas outlets that face the substrate.

However, conventional gas distributors often fail to provide a uniform gas flow distribution across the surface of the substrate. For example, a gas distributor comprising different gas nozzles often pass different flow rates of gas from different nozzles when, for example, the dimensions of the gas nozzles vary from one nozzle to another. As another example, a showerhead often has outlet holes with slightly different diameters resulting in different flow rates from each outlet hole. Further, in some designs, the gas showerhead comprises arrays of outlets with different diameters can provide gas flow rates that vary from one outlet to another within a particular array of outlets.

A further problem arises when attempting to balance the flow of gas to two separate chambers of a multi-chamber processing apparatus to get substantially similar processing rates in each chamber. In one method, micrometer valves are used to adjust the flow of process gas passing through a tube feeding the chamber, as for example, described in commonly assigned U.S. Pat. No. 6,843,882, which is incorporated by reference herein in its entirety. Separate micrometer valves can be adjusted to balance or purposely off-balance the flows to the two different chambers. However, manual adjustment of the micrometers is labor intensive and can result in operator inaccuracies. The operator physically adjusts the micrometers a certain number of turns, and such an adjustment can be changed by accidental motion of the operator. Furthermore, the level of accuracy of the balanced flow to each chamber is also often difficult to determine.

Flow ratio devices which split an input gas flow into two separate flow streams can also be used to control the gas flow to twin chambers. For example, a DELTA™ Flow Ratio Controller from MKS Instruments, Inc., Wilmington, Mass., divides the input flow into two separate flow streams. Yet another flow controlling device, the Ratio Flow Splitter (RFS) module from Celerity, Inc., Milpitas, Calif., uses a valve to divert flow from an input gas stream to two branch gas streams based on a certain set-point ratio for delivery to the multiple zones of a chamber or separate chambers. In these devices, the flow to each chamber is measured with a flow meter. While such devices are effective, the accuracy of the ratio is strongly affected by the accuracy of the flow meters, which is usually ±1% of the flow ratio. More accurate flow meters can be used for more accuracy however, such meters are expensive and add to substrate processing costs.

Thus, it is desirable to have a gas distributor that can provide known and reproducible flow rates through different nozzles to provide uniform or preset processing rates across the substrate surface. It is also desirable to accurately measure gas flow rates through the different nozzles of a gas distributor. It is further desirable to be able to adjust the flow of gas to twin chambers to obtain uniform flow rates in each chamber.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of particular drawings, and the invention includes any combination of these features, where:

FIG. 1A is a schematic sectional diagram of an embodiment of a gas flow comparator;

FIG. 1B is a schematic sectional view of an embodiment of a flow splitter comprising a T-shaped gas coupler;

FIG. 1C schematic sectional view of an embodiment of a flow restrictor;

FIG. 1D is a diagram of a Wheatstone Bridge electrical circuit;

FIG. 2 is a perspective view of an embodiment of the gas flow comparator;

FIG. 3A is a exploded perspective view of an embodiment of a nozzle holder of a gas flow comparator;

FIG. 3B is a perspective view of the assembled nozzle holder of FIG. 3A;

FIG. 4 is a schematic bottom view of an embodiment of a gas distributor;

FIG. 5 is a schematic diagram showing a gas flow comparator set up with a sampling probe and an adjustable needle valve nozzle for testing the relative flow rates of individual nozzles of a gas distributor;

FIG. 6 is a schematic diagram showing a flow comparator set up for testing the comparative flow rates of arrays of nozzles of a gas distributor mounted in an enclosure which is a vacuum chamber;

FIG. 7 is a schematic diagram showing a flow comparator set up for testing the flow rates of nozzles of a gas distributor comprising a face plate and a blocker plate;

FIG. 8 are two bar graphs of the flow conductance obtained though selected nozzles of two gas distributors using an absolute measurement flow meter;

FIG. 9 is a numerical diagram of the relative difference in volts measurements shown by a pressure gauge that correspond to flow rates measured through different nozzles of a gas distributor;

FIG. 10 is a contour map of the film thickness variation of a silicon oxide film deposited on a substrate;

FIG. 11 is a contour map of the gas flow through different nozzles of the gas distributor which was used in the deposition process of FIG. 10; and

FIG. 12 is a schematic diagram of a substrate processing apparatus having two chambers and a gas flow comparator set up for controlling the flow rates of process gas passed through the gas distributors of each chamber.

### DESCRIPTION

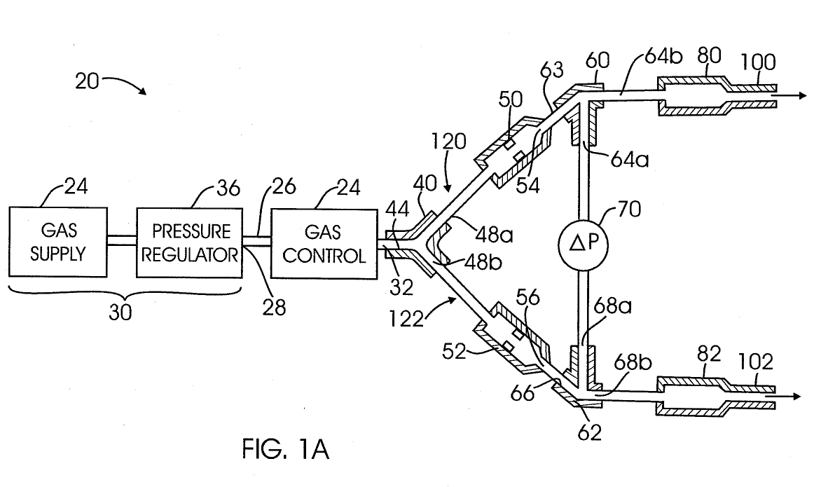

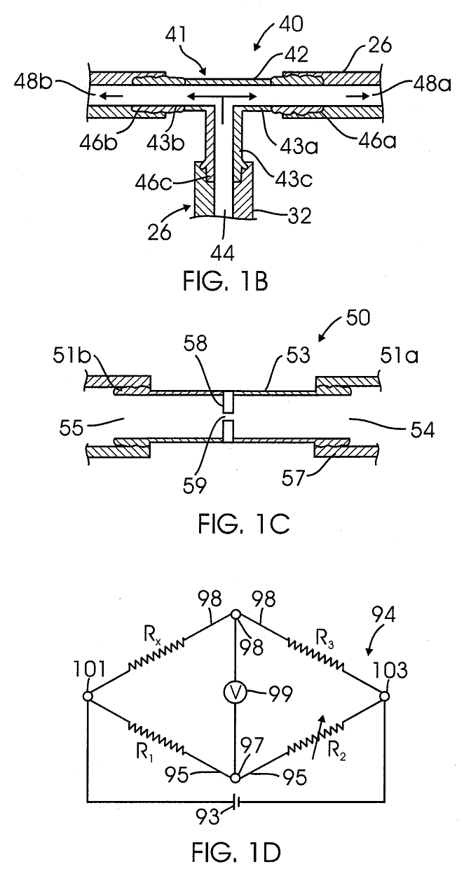

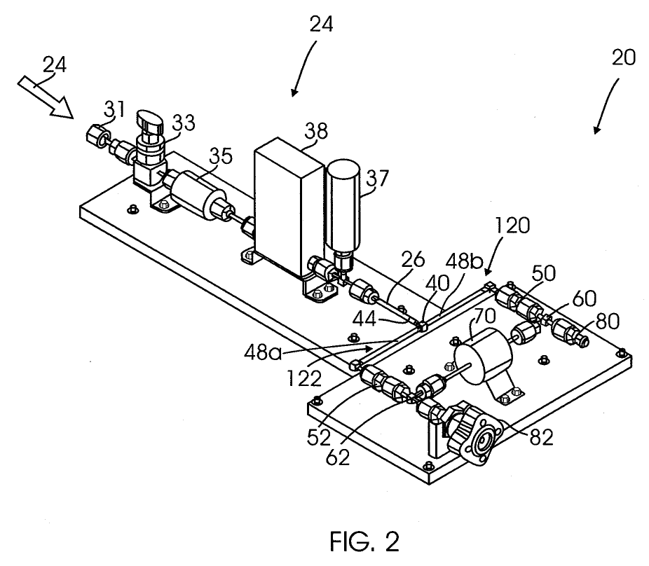

An embodiment of a gas flow comparator 20, as shown in FIGS. 1A and 2, is capable of measuring a difference in a gas parameter of a gas passing through a plurality of nozzles via a pressure differential measurement. The measured gas parameter difference can be, for example, a flow rate or pressure of the gas. The flow comparator 20 comprises a gas control 24 mounted on a gas tube 26 to set a gas flow rate or a gas pressure of the gas passing thorough the tube 26. The gas tube 26 has an inlet 28 connected to a gas source 30 and an outlet 32 through which the gas is passed out from the gas tube 26. The gas source 30 includes a gas supply 34, such as for example, a pressurized canister of a gas and a pressure regulator 36 to control the pressure of gas exiting the gas supply. In one version, the gas source 30 is set to provide a gas, such as for example, nitrogen, at a pressure of from about 50 to about 150 psia.

The gas control 24 provides gas at a selected gas flow rate or pressure to the apparatus. Referring to FIG. 2, the gas flow from a gas source (not shown) comes into the gas tube 26 through a gas coupler 31. A gas valve 33 on the gas tube 26 is manually operated to set a gas flow through the tube 26. The gas flow then passes through a gas filter 35 which can be a conventional gas filter, such as those available from McMaster Carr, Atlanta, Ga. The gas control 24 can be, for example, a gas flow control or a gas pressure regulator. In one version, the gas control 24 is a flow meter 38 such as a mass flow controller (MFC) or volumetric flow controller. The gas control 24 can comprise a gas flow control feedback loop to control a flow rate of gas passing through the gas tube 26 which is commonly known as a flow control based mass flow meter. The flow rate set on the flow meter 38 is the rate at which gas flows out of the tube outlet 32, and the mass flow meter 38 monitors the gas flow rate and adjusts an internal or external valve in response to the measured flow rate to achieve a substantially constant flow rate of gas. By substantially constant it is meant a flow rate that varies by less than 5%. The gas control 24 provides a substantially constant gas flow rate, for example, a flow rate that varies less than 5% from a nominal flow rate. A suitable flow meter 38 is a mass flow controller (MFC), from Model No. 4400, 300 sccm nitrogen, MFC from STE, Koyoto, Japan. Another version of the gas control 24 is a pressure controlled MFC, such as an MFC rated at 3000 sccm from MKS Instruments, Andover, Mass. Other suitable gas controls 24 can include MFCs from UNIT, Yuerba Linda, California. Yet another gas control 24 is a pressure regulator 36, such as a VARIFLO™ pressure regulator available from Veriflo, a division of Parker Hannifin Corporation, Cleveland, Ohio, or a pressure regulator from Swagelok, Solon, Ohio. A pressure display 37 is positioned after the flow meter 38 to read the pressure of gas applied to the gas flow comparator 20.

The gas at the constant flow rate and/or pressure is applied to a principal flow splitter 40 which has an inlet port 44 connected to the outlet 32 of the gas tube 26 to receive the gas. The flow splitter 40 splits the received gas flow to first and second output ports 48a,b. The flow splitter 40 can split the gas flow into two separate and equal gas flows or split the gas flow according to a predefined ratio. In one example, the flow splitter 40 splits the received gas flow equally between the first and second output ports 48a,b. This is accomplished by positioning the output ports 48a,b symmetrically about the inlet port 44. In one version, the principal flow splitter 40 comprises a T-shaped gas coupler 41 as shown in FIG. 1B. The T-shaped gas coupler 41 comprises a T-shaped hollow tube 42 with each leg 43a-c of the T-shaped tube having a coupling terminus 46a-c which can form a gas-tight seal with a gas tube. A suitable T-shaped coupler is a ¼″ or ½″ diameter T-fitting with a VCR coupling available from Cajon Pipe Fittings a division of Swagelok, Solon, Ohio.

First and second flow restrictors 50, 52 are each connected to the first and second output ports 48a,b respectively. Each flow restrictor 50, 52 provides a pressure drop across the flow restrictor. The pressure drop provided by each of the two restrictors 50,52 is typically the same pressure drop, but they can also be different pressure drops. In one version, the first flow restrictor 50 has a restrictor outlet 54 and the second flow restrictor 52 has a restrictor outlet 56. A cross-section of an embodiment of a flow restrictor 50, as shown in FIG. 1C, comprises a hollow tube 53 with an restrictor inlet 55 and a restrictor outlet 54 that are each within a terminus 51a,b, respectively. The terminus 51a,b is shaped to provide a gas-tight seal with an overlying gas tube 53. The flow restrictor 50 further comprises a baffle 58 with an aperture 59 having a predefined dimension that is positioned in a central portion of the tube 53. Instead of a baffle 58, the tube 53 can also narrow down from a larger diameter to a narrower diameter in a constricted section (not shown) to provide the desirable flow restriction. In yet another version, the flow restrictor 50 can comprise a nozzle. Suitable flow restrictors 50, 52 include Ruby Precision Orifices available from BIRD Precision, Waltham, Mass.

A pair of secondary flow splitters 60, 62 are connected to the restrictor outlets 54, 56 of the flow restrictors 50, 52. The first secondary flow splitter 60 comprises an inlet port 63 and a pair of first output ports 64a,b, and the second secondary flow splitter 62 also has an inlet port 66 and a pair of second output ports 68a,b. The secondary flow splitters 60,62 can also comprise the aforementioned T-shaped gas couplers 41.

A differential pressure gauge 70 is connected across the output ports 64a, 68a of the secondary flow splitters 60, 62. In one version, the differential pressure gauge 70 is suitable for measuring a pressure range of at least 1 Torr, or even at least 5 Torr, or even 50 Torr. The accuracy of the differential pressure gauge 70 depends on the pressure or flow rate of gas through the flow comparator 20. For example, a differential pressure gauge 70 having a pressure range measurement capability of 50 Torr has an accuracy of at least about ±0.15 Torr; whereas a differential pressure gauge 70 capable of measuring a pressure range of 1 Torr has an accuracy of 0.005 Torr. A suitable differential pressure gauge 70 is an MKS 223B differential pressure transducer, available from aforementioned MKS Instruments, Inc. The differential pressure gauge 70 operates by diaphragm displacement in the forward or reverse direction which generates a positive or negative voltage which corresponds to the measured pressure differential.

First and second nozzle holders 80, 82 are connected to the pair of second output ports 64b, 68b of the secondary flow splitters 60, 62. The nozzle holders 80, 82 are capable of being connected to feed gas to nozzles 100, 102, for comparative measurements of the flow rates through the nozzles. For example, the nozzle holders 80, 82 can be connected to a first reference nozzle 100, and a second test nozzle 102 which is to be tested for its flow rate relative to the reference nozzle; or the relative flow rates through two nozzles 100, 102 can be compared to one another.

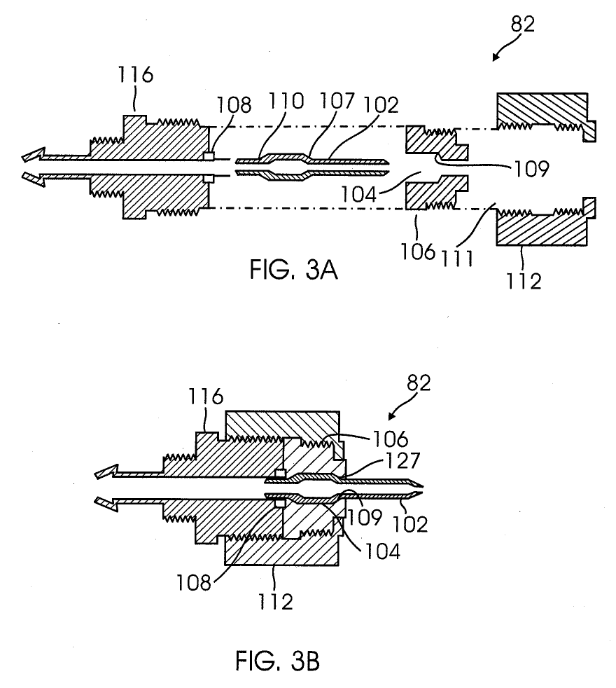

To compare the flow rate of gas through the two nozzles 100, 102, the nozzles 100, 102 are attached to the nozzle holders 80, 82. An exploded view of the installation of a nozzle 102 in a nozzle holder 82 is shown in FIG. 3A. The nozzle 102 slides into a recessed cup 104 of an polymer insert 106 so that the angled shoulder 107 of the nozzle 102 contacts the angled inner surface 109 of the polymer insert 106. A Teflon washer 108 is installed on the back end 110 of the nozzle 102 to form a sealing gasket. The assembly of the insert 106 with the nozzle 102 is then inserted into a matching cavity 111 of the ring nut 112. This assembly is then screwed onto the base coupler 116 and hand-tightened to form a good seal. The assembled nozzle holder 82 with a nozzle 102 extending out, as shown in FIG. 3B, is snap fitted to a gas coupler or tube of the flow comparator 20. When replacing the nozzle 102 with another test nozzle, the components of the nozzle holder 82 should be wipe cleaned with isopropyl alcohol.

In operation, the gas supply 34 and the gas control 24 are used to provide a constant flow rate of gas or a constant pressure of gas, to the inlet 28 of the gas tube 26 of the flow comparator 20. In one version, a pressure regulator 36 is set to provide gas at a constant pressure of, for example, from about 10 to about 150 psig, or even 40 psig. for a nozzle having a diameter of 16 mils, and a flow meter 38 is set to provide a flow rate of from about 100 to about 3000 sccm, and in one version 300 sccm. However, the set gas flow rate or gas pressure, is much larger when a large number of nozzles 102 are being measured, for example, a quadrant of nozzles 102 of a gas distributor having thousand of nozzles, for which the flow rate can be set to a level from about 80 slm to about 140 slm, or even from about 100 slm to about 120 slm.

The differential pressure gauge 70 is zeroed out at the beginning of each test session. The constant flow rate or constant pressure gas supply is provided to the principal flow splitter 40 which directs the gas through the separate first and second flow channels 120, 122 having the first and second flow restrictors 50, 52. After exiting the outlets 54, 56 of the flow restrictors 50, 52, the gas is passed through the first and second nozzles 100, 102 at least one of which is being tested. Any difference in flow rate of gas passing through, or a pressure drop across, the nozzles 100, 102 causes the pressure differential gauge 70 to register a pressure differential that is proportional to the variation in flow rate of the gas through the nozzles 100, 102. Conventional methods of measuring nozzle performance directly measure the flow through the nozzle using a mass flow meter, and such a flow measurement accuracy is limited by the measurement accuracy of the total flow through the nozzle. In contrast, the flow comparator 20 allows measurement of flow variations that are within about ±1.5% of the nominal flow rate through the nozzle 100, 102. The nozzle flow rate is measured as the percent change of the nozzle resistance through the differential pressure between the two nozzles 100, 102 and the upstream pressure. By measuring the difference in resistance, the flow comparator 20 can generate a flow measurement accuracy that is at least an order of magnitude better than conventional flow testing devices.

Operation of the flow comparator 20 can be explained with reference to a Wheatstone Bridge 94 electrical circuit as shown in FIG. 1D. A Wheatstone Bridge 94 is used to measure the unknown electrical resistance of an unknown resistor by balancing two legs of a bridge circuit, one leg of which includes the unknown resistor, which is powered by a voltage source 93. In the Wheatstone Bridge 94, Rₓ represents the unknown resistor; and R₁, R₂ and R₃ represent resistors of known resistance and the resistance of R₂ is adjustable. If the ratio of the two known resistors (R₂/R₁) in the first leg 95 is equal to the ratio of the two unknown resistors (Rₓ/R₃) in the second leg 96, then the voltage between the two midpoints 97, 98 will be zero and no current will flow between the midpoints 97, 98. R₂ is varied until this condition is reached. The current direction indicates if R₂ is too high or too low. Detecting zero current can be done to extremely high accuracy. Therefore, if R₁, R₂ and R₃ are known to a high precision value, then Rₓ can be measured to the same precision as small changes in Rₓ disrupt the balance and are readily detected. When the Wheatstone Bridge 94 is balanced, which means that the current through the galvanometer 99 (R_{g}) is equal to zero, the equivalent resistance (R_{E}) of the circuit between the source voltage terminals 101, 103 is determined by R₁+R₂ in parallel with R₃+R₄, as follows:

R_{E}={(R₁+R₂)·(R₃+Rₓ)}/{R₁+R₂+R₃+R₄}

### Alternatively, if R₁, R₂, and R₃ are known, but R₂ is not adjustable, the voltage or current flow through the galvanometer 99 can be used to calculate the value of Rₓ, using Kirchhoff's circuit laws (also known as Kirchhoff's rules).

In the flow comparator 20 shown in FIGS. 1A and 2, the flow restrictors 50, 52 and the nozzles 100, 102 are represented or equivalent to the fixed resistors, adjustable resistor, and unknown resistor of the Wheatstone Bridge 94 of FIG. 1D. For the flow comparator 20, the flow restrictors 50, 52 represent fixed flow resistances R₁ and R₂, respectively, which are equal in value so R₁=R₂=Rᵤ. Further, the nozzles 100, 102 represent flow resistances R₃ and R₄, respectively, which also should be equal in value so R₃=R₄=R_{d}=k Rᵤ, where k>1. However, if R₄ varies by ΔR from R₃ then the differential pressure is given by:

ΔP=Q {ΔR/[2(1+k)+ΔR/Rᵤ]}

### When this equation is linearized, ΔP α ΔR, and thus, the differential pressure measured by the flow comparator 20 is proportional to the flow resistance of the two nozzles 100, 102.

In one version, a kit of calibration nozzles can also be used to verify that the flow comparator 20 is in proper working order. The kit can have different types of nozzles 100, 102 or multiple nozzles of the same type, that is with the same orifice dimensions. For example, the kit of nozzles can contain nozzles having an opening that is sized from about 0.0135 to about 0.0210 inches, at increments of 0.0005 inch. The kit of calibration nozzles can also be ceramic nozzles from Kyocera, Japan, which have a controlled orifice size. The kit is useful to calibrate nozzles that are being tested to determine the actual flow rate of the test nozzles.

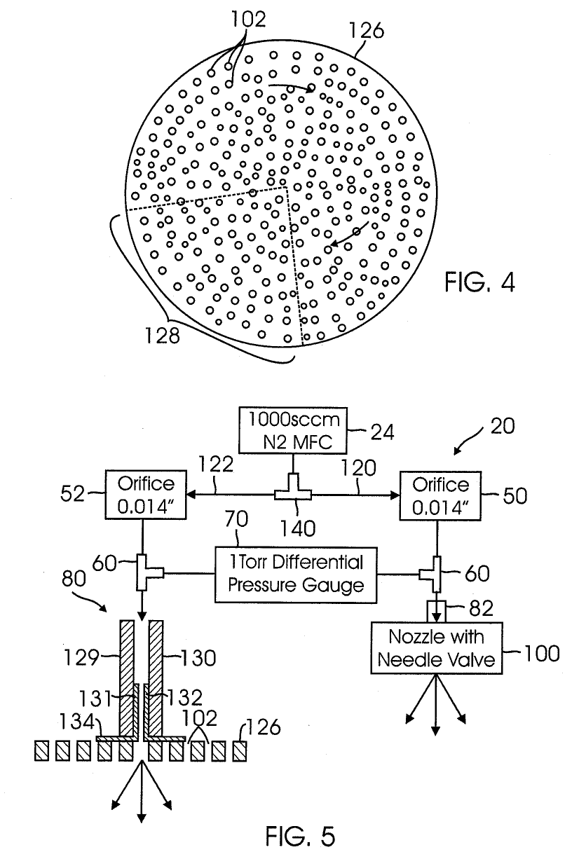

In another version, the flow comparator 20 is adapted to connect to nozzles 102 of a gas distributor 126 which is used to distribute process gas to substrate processing chambers. The gas distributor 126, a version of which is shown in FIG. 4, comprises a plurality of spaced apart nozzles 102, for example, the nozzles 102 can number from about 100 to about 10,000, or even from about 1000 to about 6000. FIG. 5 shows a set up suitable for testing the flow rates of individual nozzles 102 of the gas distributor 126. In this set up, the nozzle holder 80 comprises a sampling probe 130 which is used to sample the flow rate of each individual nozzle 102 of the gas distributor 126. In one type of sampling operation, the sampling probe 130 is positioned over a particular nozzle 102 to measure the relative flow rate of that individual nozzle relative to a reference nozzle 100. The nozzle holder 82 is connected to a reference nozzle 100 which can be a fixed dimension nozzle or an adjustable nozzle having an opening whose dimension is adjusted with an adjustable needle valve 132, as shown in FIG. 5. In the latter case, the needle valve 132 is set to match the measured conductance of a single selected nozzle 102 on the gas distributor 126 and then the probe 130 is moved from nozzle to nozzle to check the flow rate through each nozzle. This method allows verification of the uniformity of gas flow rates through the nozzles 102 of the gas distributor 126. In this set up, the gas control 24 comprised a flow meter 38 comprising a mass flow controller that was set to provide a flow rate of 1000 sccm of nitrogen gas. The flow restrictors 50, 52 in the gas flow channels 120, 122, respectively, were nozzles having orifice diameters of about 0.35 mm (0.014 in). The differential pressure gauge 70 had a differential pressure measurement range of 1 Torr.

In one version, the sampling probe 130 comprises a first tube 129 having a first diameter, and connected to a second tube 131 having a second diameter which is smaller than the first diameter. For example, the first tube 129 can have a first diameter of about 6.4 mm (0.25 in), and receives a second tube 131 have a second smaller diameter of 3.2 mm (0.125 in). The tubes 129, 131 can be plastic tubes. An O-ring seal 134 is mounted around the opening of the second tube 131 of sampling probe 130 to form a seal, and the O-ring seal 134 can be, for example, a silicon rubber ring having an internal hole with a diameter of about 3.2 mm (0.125 in), and an external size of about of 6.4 mm (0.125 in) or larger. In one version, the silicon rubber ring has a Durometer hardness measurement of about 20. The silicon rubber ring can be for example, 20 durometer super-soft silicon rubber, available from McMaster-Carr, Atlanta Ga. In another version, the sampling probe 130 comprises a VCO fitting suitable for forming a gas tight seal against a flat surface, and having a flat end with a groove therein and an O-ring gasket in the groove. A suitable O-ring can have a diameter of about 3.2 mm (0.125 in). The gas supplied to the flow comparator 20 can be nitrogen.

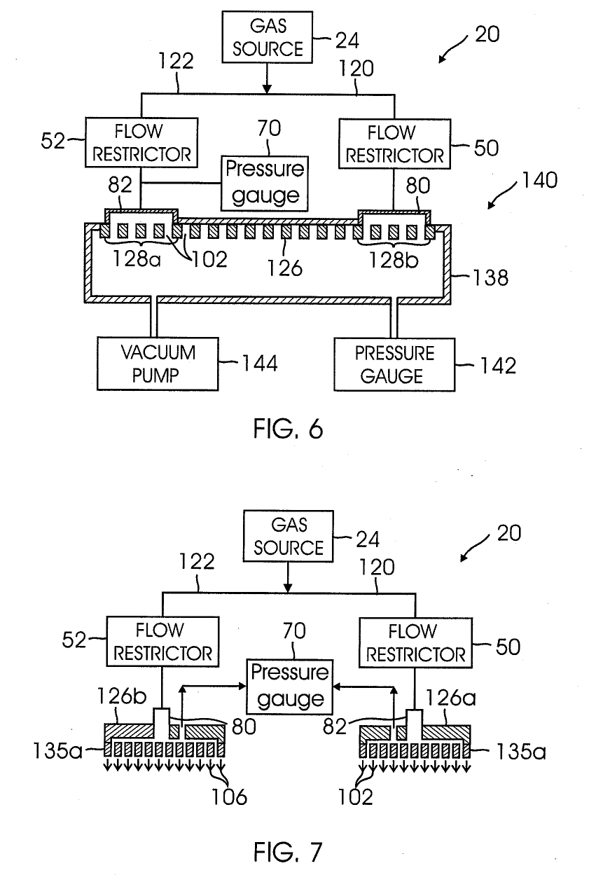

In still another measurement method, the flow comparator 20 is used to measure the relative gas flow conductance of two or more arrays 128a,b of nozzles 102 of a single gas distributor 126 mounted in an enclosure 138, as shown in FIG. 6, which can be a vacuum chamber or a process chamber of a substrate processing apparatus 140. In this set up, a nozzle holder 80 is adapted to pass gas through a single nozzle 102 or a selected array 128a,b of nozzles 102 of a gas distributor 126, as for example shown in FIG. 4, while sealing off other remaining holes of the plate 126. The enclosure 138 has a pressure gauge 142 to measure the pressure in the chamber, which is for example, a BARATRON pressure gauge from aforementioned MKS Instruments, Inc, which has a diaphragm and is capable of measuring pressures of up to 100 Torr. The enclosure 138 also has a vacuum pump 144, such as a mechanical displacement vacuum pump, for example, a QDP-80 from Edwards BOC Company, England. The nozzle holders 80 and 82 are adapted to measure the relative conductance of the two arrays 128a,b that comprise a quadrant of the nozzles 102 of a gas distributor 126 by forming a gas tight seal around the two quadrants. A jig (not shown) can also be used to seal off other nozzles 102 of the gas distributor 126 which are not being measured to allow measurement of only the gas flow rates through only the open nozzles 102. The jig is simply a sealing device to cover up the nozzles 102. By measuring the average flow rate through individual arrays 128a,b of nozzles 102 in the gas distributor 126, the flow rate through different quadrants or regions can be compared. This can be used as a qualification test to disqualify gas distributors 126 having non-uniform arrays 128a,b of nozzles 102 that result from poor machining or other fabrication of the nozzles 102.

Another measurement method that can be used with the flow comparator 20 comprises measuring a gas flow conductance rates of nozzles of two gas distributors 126a,b each comprising a face plate facing a blocker plate 135a,b with a large number of nozzles 100, 102, respectively, and which vent to a clean room environment, as shown in FIG. 7. The total flow and uniformity of flow through nozzles 102 of the separate mounted plates 126a,b (or of a single plate 126) should be the same, otherwise non-uniform processing occurs during the processing of substrates using the plate(s). A set up suitable for comparing total flow rates through two plates 126a,b comprises mounting the flow comparator 20 so that each nozzle holder 80, 82 is connected to a nozzle 102, or array 128 of nozzles 102 of the distributor plates 126a,b. The flow comparator 20 measures the percent difference in flow resistance or conductance by measuring the differential pressure between the two plates 126a,b and the upstream or input gas pressure from the gas source 30. By measuring the difference in flow resistance, this flow comparator 20 can be used to achieve accurate flow rate, and uniformity of flow data which can be used to improve the matching of gas distributors 126a,b for twin chambers 138a,b.

A setup suitable for comparing total flow rates through two plates 126a,b comprises a flow comparator 20 mounted so that each nozzle holder 80, 82 is connected to an input gas manifold 144a,b of each chamber 138a,b, which feeds a separate gas distributor 126a,b. In this set up, the flow comparator 20 measures the percent difference in flow resistance or conductance by measuring the differential pressure between the two manifolds 144a,b and the upstream or input gas pressure from the gas source 30. By measuring the difference in resistance, this flow comparator 20 can be used to achieve accurate flow rate, and uniformity of flow data which can be used to improve the matching of gas distributors 126a,b in twin chambers 138a,b.

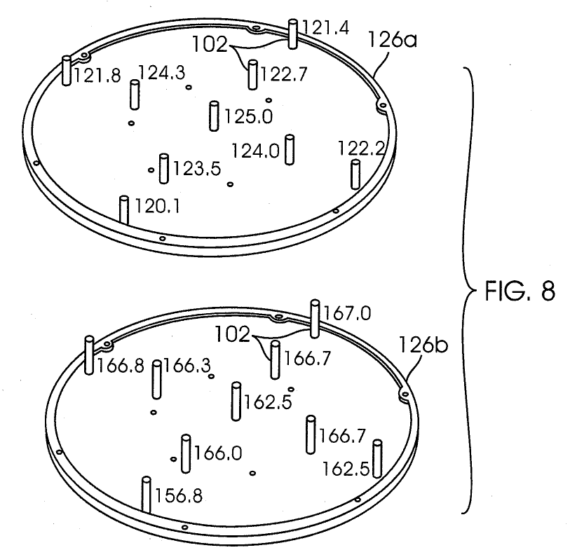

The variation in absolute flow rates that can occur between different nozzles 102 of a gas distributor 126, or different gas distributors 126a,b, as measured using conventional flow measuring apparatus is shown in FIG. 8. The flow conductance rates obtained though selected nozzles 102 of two different gas distributors 126a,b are provided on the graph. The first plate 126a had nozzles 102 sized 0.6 mm (0.024 in) and the second plate 126b had nozzles sized 0.7 mm (0.028 in). Even though the flow rates though the nozzles were quite different varying from 120 to 125 sccm in the first plate 126a, and from 156 to 167 sccm in the second plate 126b, when fewer than 1% of selected nozzles 102 in the two plates 126a,b were closed off, the plates 126a,b provided balanced flow rates. Comparison of two equivalent arrays 128 of nozzles comprising quadrants of the plates 126a,b also resulted in closer than 1% agreement in flow rates between the quadrants. However, the different flow rates through different nozzles 102 can produce significantly different deposition or etching rates on a substrate. Thus, this demonstrates that the flow measurements of individual nozzles 102 of a gas distributor plate 126 are important to measure and can vary substantially. In this example, the flow measurement device was a MOLBLOC, from DH Instruments, Tempe Arizona.

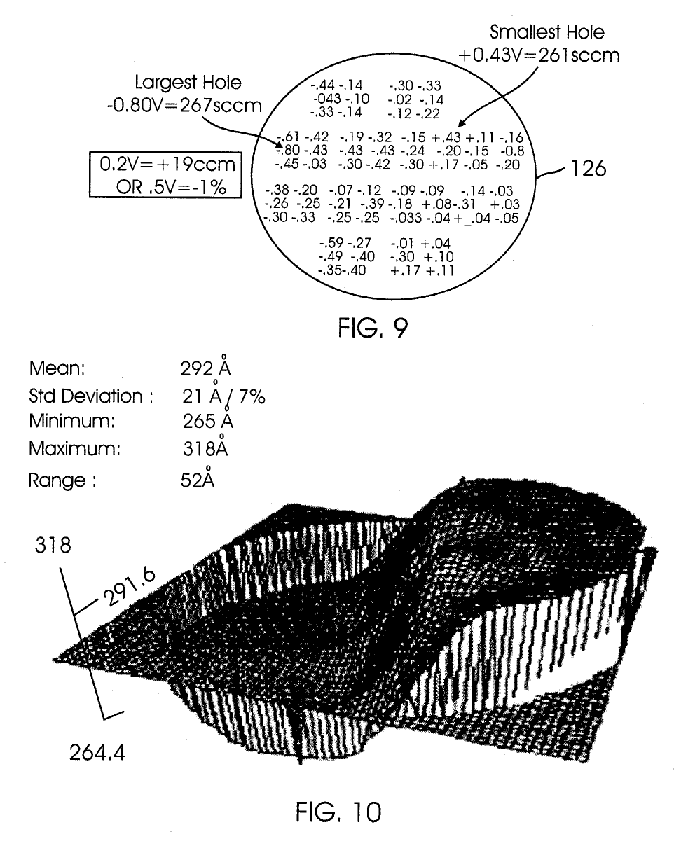

A graph of the variation in the relative difference of sampled flow rates through individual nozzles 102 of a gas distributor 126, in volts measured by the differential pressure gauge 70, is shown in FIG. 9. In this graph, different nozzles of a gas distributor 126, with +0.43 V equivalent to a flow rate of 261 sccm through a nozzle, and −0.80 V equivalent to 267 sccm. A range of differential flow rates were measured for selected nozzles 102 to yield a flow contour map which can be correlated to process uniformity maps of thickness or other surface characteristics of material processed on a substrate 160. By performing differential pressure measurements as opposed to absolute flow measurements using a flow meter, much higher accuracies in the flow rate measurements were achieved. In one example, flowing 140 slm of N₂ through gas distributors 126 with blockers resulted in 8 mV shifts per blocked hole, when the resolution of the differential pressure gage 70 was 1 mV. Even with flow fluctuations this provides the capability of detecting a single hole being covered out of more than a thousand nozzles in a plate 126. Whereas a typical mass flow meter gave absolute flow measurements which were accurate only to about 0.5%; the present method easily achieved flow accuracies better than 0.1% compared to a reference nozzle 102.

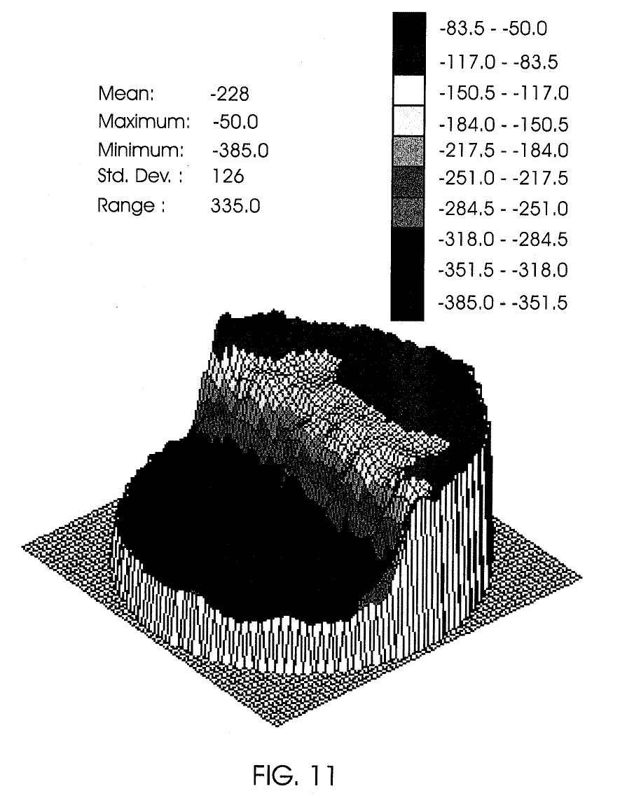

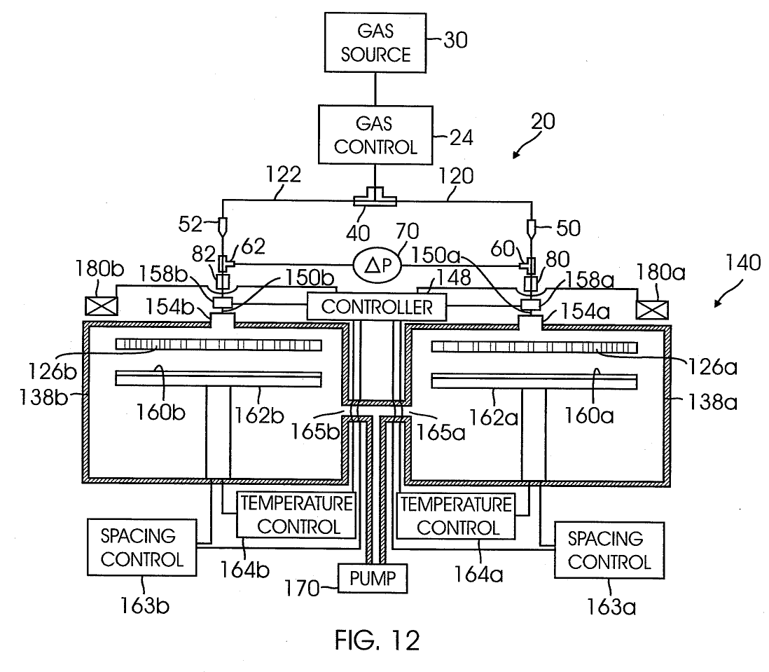

The thickness of a silicon oxide film deposited on a substrate 160 using silane gas in a process chamber was measured and shown in the contour map of FIG. 10. The film thickness varied widely across the by about 52 angstroms, with a mean of 291 angstroms, and a range from about 266 to about 318 angstroms. It was also found that the deposition thickness varied with rotation of the gas distributor 126 in the chamber. The flow comparator 20 was then used to measure a flow uniformity contour map of the gas distributor 126 used to process the substrate 160, as shown in FIG. 11. The flow contour map was co-related to the substrate thickness deposition map as both maps exhibited matching waterfall patterns, with higher flows from the gas distributor providing correspondingly higher deposition thicknesses. In this example, it was determined that changes in the drilling methods used to create the small nozzle holes, that is using multiple drills bits with a 180° rotation of the plate during the drilling procedure or a single drill bit which gradually abrades away after drilling a large number of holes, resulted in nozzles 102 with different diameters across the gas distributor 126.

In another measurement set up, an automated flow uniformity mapping fixture can be used to measure the flow uniformity of different nozzles 102 of a gas distributor plate 126. For example, the fixture can include a flow comparator and an X-Y-Z motion stage to move the sample probe 130 across the plate 126 to different nozzles to test each nozzle 102. This test fixture allows measurement of a complete flow contour map for each new gas distributor 126.

A substrate processing apparatus 140 can also comprise a gas flow controller 141 to control a plurality of gas flow rates through nozzles 102 that introduce process gas into a plurality of substrate processing chambers 138a,b. In one version, the gas flow controller 141 comprises the flow comparator 20 and is used to automatically adjust the flow rates of the process gas to the chambers 138a,b. The process gas can be activated in a remote plasma source, such as an RPS source made by Astron, Irvine, Calif. Each chamber 138a,b comprises an input gas line 150a,b which feeds process gas to a gas manifold 154a,b which in turn feeds the gas to a gas distributor 126a,b. In operation, passage of a process gas through the first and second flow restrictors 50, 52 and nozzle holders 80, 82 of the flow comparator 20, the nozzle holders being connected to input gas lines 150a,b that feed the gas distributors 126a,b in the chambers 138a,b causes the pressure differential gauge 70 of the flow comparator 20 to register a pressure differential that is proportional to the variation in flow rate of the gas through the nozzles 102.

In operation, a pressure differential signal is sent from the pressure differential gauge 70 to a controller 148, which in response to the signal, adjusts a flow adjustment valve 158a,b connected to the input gas line 150a,b of a substrate processing chamber 138a,b, to form a closed loop control system. The flow adjustment valves 158a,b are each connected at one end to an output port 64b, 68b of a secondary flow splitter 60,62, respectively, and at another end to an input gas line 150a,b of a chamber 1.38a,b which feeds the gas distributor 126a,b in the chamber. The flow adjustment valves 158a,b control the flow of process gas passing through the input gas lines 150a,b in response to a flow control signal received from the controller 148. In the version shown, the differential pressure gauge 70 is positioned before the flow adjustment valves 158a,b. Since the gauge 70 has a high flow impedance, the gauge 70 has a minimal effect on the flow rates of the process gas passed through the valves 158a,b and gas lines 150a,b. Thus, the differential pressure gauge can also be placed in other locations along the gas supply channels.

The chambers 138a,b can also be used as enclosures 133 that serve as vacuum test fixtures to test the differential flow through the distributor plates 126a,b. The differential pressure gauge measures the differential pressure of the gas applied to input tubes that supply process gas to each chamber 138a,b.

In one version, the flow adjustment valves 158a,b are mechanized to allow automation of the flow adjustment in response to a differential pressure signal from the differential pressure gauge 70. For example, the valves 158a,b can be electrically actuated or manual actuated. In one embodiment, the two valves 158a,b are adjusted until the desired set-point is reached for a signal corresponding to a measured differential pressure of 0 Torr from the differential pressure gauge 70. Similarly, if the desired set-point is −2 Torr, for example, when un-equal flow rates are desired to each gas distributor 126a,b, the valves 158a,b can be adjusted accordingly. This allows the differential pressure to be set in the process recipe and to be automatically implemented during operation of the apparatus 140. In fact, zero differential pressure may not provide the best results, but would lead to an evenly split flow between the two gas lines 150a,b. Advantageously, differential backpressure differences of as little as 0.1 mtorr can be used to resolve flow differences down to 0.1% of total flow rates, or even 0.01% of flow rates, in contrast to conventional flow control meters which can provide resolution of flow differences only to about 1% of total flow rates, which represents a 10 times better flow resolution.

The apparatus 140 can be, for example, a Producer™ with twin chambers 138a,b from Applied Materials, Santa Clara, Calif. The pair of processing chambers 138a,b is disposed one above the other and each chamber provides the capability of processing one or more substrates 160. The chambers 138a,b can be used, as one example of many possible uses, for the deposition of silicon oxide films using silane gas on substrates 160 comprising silicon wafers, the wafers having dimensions of 300 mm. In one embodiment, the chambers 138a,b include identical components to carry out identical semiconductor processing operations, or identical sets of processing operations. Being identically configured allows the chambers 138a,b to simultaneously perform identical chemical vapor deposition operations in which an insulating or a conductive material is deposited on a wafer disposed in each respective chamber 138a,b. In other embodiments, the identical semiconductor processing chambers 138a,b are used for etching substrates 160, such as silicon wafers, typically through openings in a photoresist or other type of masking layer on the surface of the wafer. Of course, any suitable semiconductor operation can be performed simultaneously in the chambers 138a,b, such as plasma vapor deposition, epitaxial layer deposition, or even etching processes such as pas etch, etch back, or spacer etch processes. As will be described, the choice of such operation is arbitrary within the context of the system described herein.

Substrates 160a,b such as silicon wafers or other type semiconductor wafers, are transported to each chamber 138a,b to rest on a substrate support 162a,b. Each substrate support 162a,b can include a temperature control 164a,b comprising a heater, to heat the substrate 160a,b. Equalizing gas flows through the chambers 138a,b alone does not necessarily equalize film deposition rates or produce the same processing results in the chambers 138a,b. For instance, there may still be variations in the film thicknesses due to other factors such as temperature differences and the spacing between the gas distributors 126a,b and the substrates 160a,b. Wafer temperature is adjusted by varying the temperature of the substrate supports 162a,b using the temperature control 164a,b. Spacing is adjusted using a spacing control 163a,b connected to the substrate support 162a,b.

The chambers 138a,b each have exhaust ports 165a,b connected to separate exhaust lines 166a,b that join to form a common exhaust line 168 which leads to a vacuum pump 170. In operation, the chambers 138a,b are pumped down to low pressures using a pump, such as a vacuum pump for example a combination of roughing, turbomolecular, and other pumps to provide the desired pressure in the chambers 138a,b. Downstream throttle valves 174a,b are provided in the exhaust lines 166a,b to control the pressure of the gas in the chambers 138a,b.

When used for plasma enhanced processes, the chambers 138a,b, can also have gas energizers 180a,b. The gas energizers 180a,b can be electrodes within the chambers 138a,b, an induction coil outside the chambers, or a remote plasma source such as a microwave or RF source. The gas energizers 180a,b are used to set the power level applied to generate and sustain the plasma or activated gas species in the chambers 138a,b.

The foregoing description of various embodiments of the invention has been provided for the purposes of understanding of the invention. The description is not intended to be exhaustive or to limit the invention to precise forms described. For example, embodiments of the present invention may be used to match three or more chambers. Moreover, one or more of the chambers in the multiple chamber system may be configured to process simultaneously more than one wafer. Accordingly, numerous modifications and variations are possible in view of the teachings above.

What is claimed is:

1. A gas flow comparator comprising:
(a) a gas control mounted on a gas tube, the gas control comprising a gas control feedback loop to control a flow rate or pressure of a gas passing through the gas tube;
(b) a principal flow splitter comprising an inlet port to receive gas from the gas tube, and a pair of output ports;
(c) a pair of flow restrictors that are each connected to an output port of the principal flow splitter,each flow restrictor having a restrictor outlet;
(d) a pair of secondary flow splitters each connected to a restrictor outlet of a flow restrictor, and each secondary flow splitter comprising pairs of first and second output ports;
(e) a differential pressure gauge connected to both first output ports of the secondary flow splitters; and
(f) a pair of nozzle holders that are connected to the second output ports of the secondary flow splitters, the nozzle holders capable of being connected to first and second nozzles, whereby passage of gas through the flow restrictors and the first and second nozzles causes the pressure differential gauge to register a pressure differential proportional to a difference in flow rates of gas through the first and second nozzles.

2. A comparator according to claim 1 wherein the differential pressure gauge is suitable for measuring a pressure range of at least about 1 Torr.

3. A comparator according to claim 1 wherein differential pressure gauge has an accuracy of at least about 0.001 Torr.

4. A comparator according to claim 1 wherein the principal and secondary flow splitters each comprise a T-shaped gas coupler.

5. A comparator according to claim 1 wherein the flow restrictors comprise a baffle with an aperture.

6. A comparator according to claim 1 wherein the nozzle holders are adapted to be connectable to an input tube of a gas distributor in a process chamber, the gas distributor comprising a plurality of spaced apart nozzles.

7. A comparator according to claim 6 comprising a jig adapted to seal around the nozzles of at least one quadrant of the gas distributor, thereby allowing measurement of a gas flow rate through the quadrant.

8. A comparator according to claim 1 comprising a sampling probe to sample the flow rate of an individual hole of a gas distributor having a plurality of holes.

9. A comparator according to claim 8 wherein the sampling probe comprises a first tube connected to a second tube, the first tube having a first diameter and the second tube having a second diameter which is smaller than the first diameter, and an O-ring seal mounted around the opening of the second tube.

10. A comparator according to claim 9 wherein the O-ring seal comprises a silicon rubber ring.

11. A comparator according to claim 1 wherein the first nozzle comprises a test nozzle and the second nozzle comprises an adjustable needle valve.

12. A comparator according to claim 1 further comprising a kit of calibration nozzles.

13. A gas flow comparator comprising:
(a) a gas control mounted on a gas tube to set a selected gas flow or pressure of a gas passing thorough the gas tube using a gas control feedback loop;
(b) a principal flow splitter comprising an inlet port connected to the gas tube, and output ports;
(c) a pair of flow restrictors that are each connected to an output port of the principal flow splitter, each flow restrictor having a restrictor outlet;
(d) a pair of secondary flow splitters each connected to a restrictor outlet of a flow restrictor, each secondary flow splitter comprising pairs of first and second output ports;
(e) a differential pressure gauge connected to both first output ports of the secondary flow splitters; and
(f) a pair of nozzle holders connected to the second output ports of the secondary flow splitters, the nozzle holders capable of being connected to first nozzle comprising a test nozzle and a second nozzle comprises an adjustable needle valve, whereby passage of a flow of gas through the first and second flow restrictors and the first and second nozzles, causes the pressure differential gauge to register a pressure differential proportional to a variation in the rates of flow of gas through the first and second nozzles.

14. A comparator according to claim 13 wherein the differential pressure gauge is suitable for measuring a pressure range of at least about 1 Torr.

15. A comparator according to claim 13 wherein differential pressure gauge has an accuracy of at least about 0.001 Torr.

16. A comparator according to claim 13 wherein the principal and secondary flow splitters each comprise a T-shaped gas coupler.

17. A comparator according to claim 13 wherein the flow restrictors each comprise a baffle with an aperture.

18. A comparator according to claim 13 wherein the nozzle holders are adapted to be connectable to an input tube of a gas distributor in a process chamber, the gas distributor comprising a plurality of spaced apart nozzles.

19. A comparator according to claim 18 comprising a jig adapted to seal around the nozzles of at least one quadrant of the gas distributor, thereby allowing measurement of a gas flow rate through the quadrant.

20. A comparator according to claim 13 comprising a sampling probe to sample the flow rate of an individual hole of a gas distributor having a plurality of holes.

21. A comparator according to claim 20 wherein the sampling probe comprises a first tube connected to a second tube, the first tube having a first diameter and the second tube having a second diameter which is smaller than the first diameter, and an O-ring seal mounted around the opening of the second tube.

22. A comparator according to claim 21 wherein the O-ring seal comprises a silicon rubber ring.

23. A gas controller comprising:
(a) a gas flow comparator comprising:
(1) a principal flow splitter comprising an inlet port to receive a gas, and first and second output ports;
(2) first and second flow restrictors connected to the first and second output ports, respectively, each flow restrictor having a restrictor outlet;
(3) a pair of secondary flow splitters that are each connected to a restrictor outlet of a gas flow restrictor, the secondary flow splitters each comprising pairs of first and second output ports;
(4) a differential pressure gauge connected to both first output ports of the secondary flow splitters, the pressure differential gauge capable of generating a signal in relation to a measured pressure differential caused by the passage of a process gas through the gas distributor in each chamber; and
(b) a plurality of flow adjustment valves that are each connected at one end to a second output port of a secondary flow splitter of the gas flow comparator and at another end to a gas inlet tube of the substrate processing chamber which feeds a gas distributor in the chamber; and
(c) a controller to adjust the flow adjustment valves to control a flow of gas through the valves in response to the signal received from the pressure differential gauge.

24. A flow controller according to claim 23 wherein the flow adjustment valves comprise mass flow controllers.

25. A flow controller according to claim 23 wherein the differential pressure gauge is suitable for measuring a pressure range of at least about 1 Torr.

26. A flow controller according to claim 23 wherein differential pressure gauge has an accuracy of at least about 0.001 Torr.

27. A flow controller according to claim 23 wherein the principal and secondary flow splitters each comprise a T-shaped gas coupler.

28. A flow controller according to claim 23 wherein the first and second flow restrictors comprise a baffle with an aperture.

29. A substrate processing apparatus comprising:
(a) first and second processing chambers, each chamber comprising a gas inlet tube feeding a gas distributor, a substrate support facing the gas distributor, and an exhaust port through which gas is exhausted;
(b) a gas flow comparator comprising:
(1) a principal flow splitter comprising an inlet port to receive a process gas, and first and second output ports;
(2) first and second flow restrictors connected to the first and second output ports, respectively, each flow restrictor having a restrictor outlet;
(3) a pair of secondary flow splitters that are each connected to a restrictor outlet of a gas flow restrictor, the secondary flow splitters each comprising pairs of first and second output ports;
(4) a differential pressure gauge connected to both the first output ports of the secondary flow splitters, the pressure differential gauge capable of generating a signal in relation to a measured pressure differential caused by the passage of a process gas through the gas distributor in each chamber; and
(5) a plurality of flow adjustment valves that are each connected at one end to a second output port of a secondary flow splitter and at another end to a gas inlet tube of a substrate processing chamber which feeds a gas distributor in a processing chamber; and
(c) a controller to adjust the flow adjustment valves of the gas flow comparator to control a flow of gas through the valves in response to the signal received from the pressure differential gauge.

30. An apparatus according to claim 29 wherein the flow adjustment valves comprise mass flow controllers.

31. An apparatus according to claim 29 wherein the differential pressure gauge is suitable for measuring a pressure range of at least about 1 Torr.

32. An apparatus according to claim 29 wherein differential pressure gauge has an accuracy of at least about 0.001 Torr.

33. An apparatus according to claim 29 wherein the principal and secondary flow splitters each comprise a T-shaped gas coupler, and the first and second flow restrictors comprise a baffle with an aperture.
